(19) United States
(12) Patent Application Publication
(10) Pub. No.: US 2023/0057635 A1
(43) Pub. Date: Feb. 23, 2023

(54) PROCESS MANAGEMENT METHOD, PROGRAM, AND PROCESS MANAGEMENT SYSTEM

(71) Applicant: Panasonic Intellectual Property Management Co., Ltd., Osaka (JP)

(72) Inventors: Masataka HAYASHI, Aichi (JP); Masashi NAKAYAMA, Kyoto (JP); Tomoyuki ICHIKAWA, Osaka (JP); Yu OGASAWARA, Kyoto (JP)

(73) Assignee: Panasonic Intellectual Property Management Co., Ltd., Osaka (JP)

(21) Appl. No.: 17/796,999

(22) PCT Filed: Feb. 9, 2021
(86) PCT No.: PCT/JP2021/004846

§ 371 Date: Aug. 2, 2022

(30) Foreign Application Priority Data
Feb. 10, 2020 (JP) 2020-020985

(51) Int. Cl. G06Q 10/10; H04N 7/18; G11B 27/10; G11B 27/34

(52) U.S. Cl. CPC G06Q 10/1091; H04N 7/183; G11B 27/102; G11B 27/34

(57) ABSTRACT

A process management method includes a work time acquisition step, an image acquisition step, and an association step. The work time acquisition step includes acquiring work time information about a work time for which a person performs work, including a predetermined operation, in a work area. The image acquisition step includes acquiring image information about an image captured by an image capture device and covering at least the work area. The association step includes associating the work time information acquired in the work time acquisition step and the image information acquired in the image acquisition step with each other as association information.

### TECHNICAL FIELD

The present disclosure generally relates to a process management method, a program, and a process management system. More particularly, the present disclosure relates to a process management method, a program, and a process management system, all of which are configured or designed to manage a work process performed by a person.

### BACKGROUND ART

Patent Literature 1 discloses an equipment operating rate monitor for recording the operating condition of production equipment. This equipment operating rate monitor is electrically connected to the production equipment and motors the operating condition of the production equipment to record operating data. The equipment operating rate monitor includes a detection sensor unit and an operating rate monitor body. The detection sensor unit transforms an audio signal, an optical signal, or any other signal supplied from the production equipment into an electrical signal. The operating rate monitor body aggregates operating data based on the electrical signal supplied from the detection sensor unit.

The equipment operating rate monitor of Patent Literature 1 may record the operating condition of the production equipment but cannot recognize the state of the work being performed by a person, which is a problem with the monitor of Patent Literature 1.

### CITATION LIST

### Patent Literature

Patent Literature 1: JP 2001-100820 A

### SUMMARY OF INVENTION

An object of the present disclosure is to provide a process management system, a process management method, and a program, all of which make it easier to recognize the state of the work being performed by a person.

A process management method according to an aspect of the present disclosure includes a work time acquisition step, an image acquisition step, and an association step. The work time acquisition step includes acquiring work time information about a work time for which a person performs work, including a predetermined operation, in a work area. The image acquisition step includes acquiring image information about an image captured by an image capture device and covering at least the work area. The association step includes associating the work time information acquired in the work time acquisition step and the image information acquired in the image acquisition step with each other as association information.

A program according to another aspect of the present disclosure is designed to cause one or more processors to perform the process management method described above.

A process management system according to still another aspect of the present disclosure includes a work time acquirer, an image acquirer, and an associator. The work time acquirer acquires work time information about a work time for which a person performs work, including a predetermined operation, in a work area. The image acquirer acquires image information about an image captured by an image capture device and covering at least the work area. The associator associates the work time information acquired by the work time acquirer and the image information acquired by the image acquirer with each other as association information.

### BRIEF DESCRIPTION OF DRAWINGS

FIG. 1 is a block diagram illustrating a schematic configuration for a process management system according to an exemplary embodiment of the present disclosure;

FIG. 2 is a schematic representation illustrating a work area in which the process management system is used;

FIG. 3 is a flowchart showing an exemplary first operation of the process management system;

FIG. 4 is a flowchart showing an exemplary second operation of the process management system;

FIG. 5 is an exemplary graph to be displayed on a display device in the process management system;

FIG. 6 shows an exemplary image played back on the graph;

FIG. 7 shows other exemplary images played back on the graph;

FIG. 8 shows other exemplary images played back on another exemplary graph displayed on the display device in the process management system;

FIG. 9 is a block diagram illustrating a schematic configuration for a process management system according to a first variation of the exemplary embodiment of the present disclosure; and

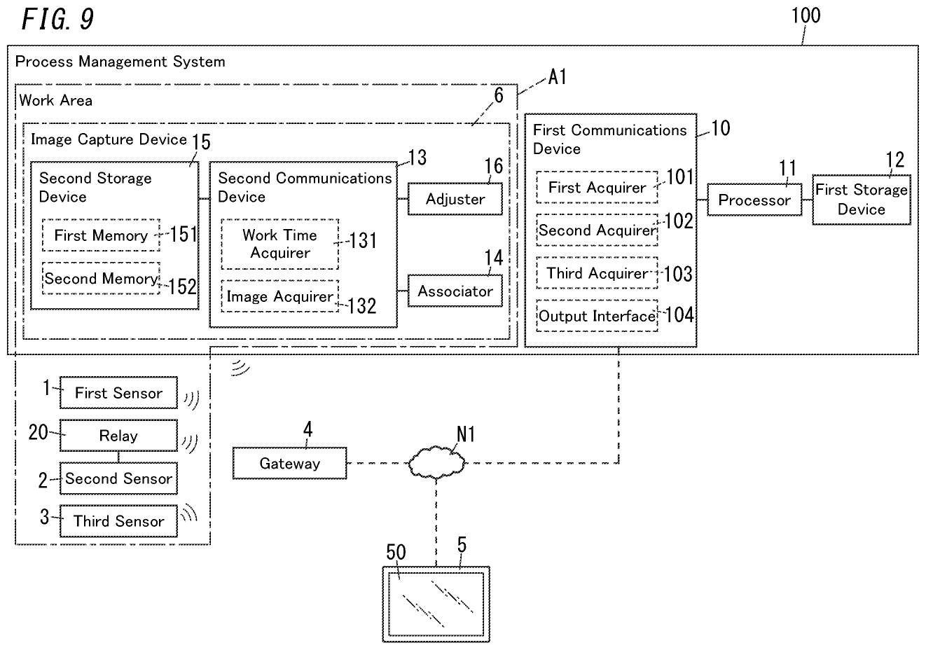

FIG. 10 is a block diagram illustrating a schematic configuration for a process management system according to a second variation of the exemplary embodiment of the present disclosure.

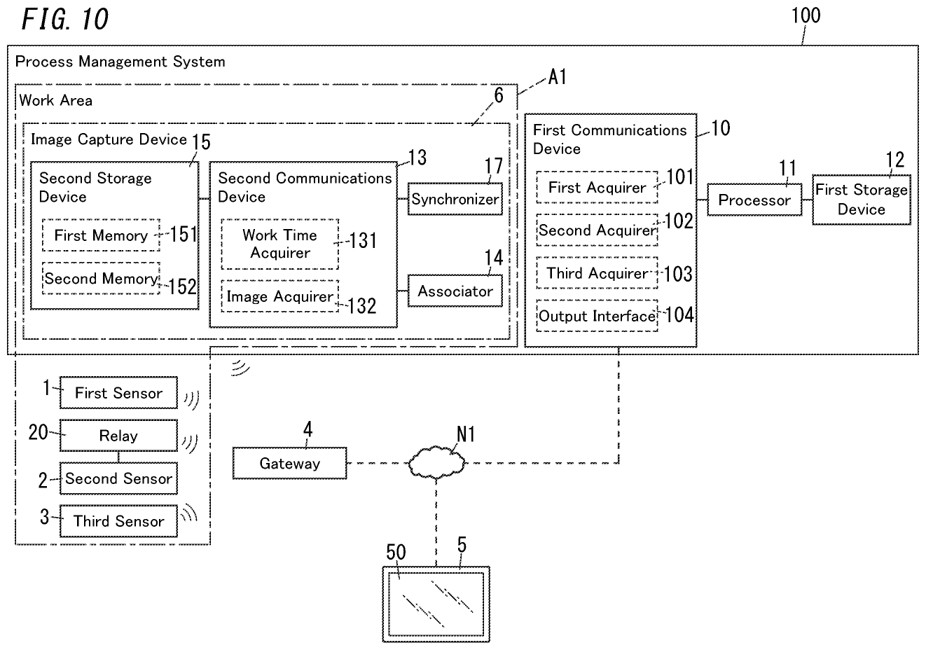

### DESCRIPTION OF EMBODIMENTS

(1) Overview

A process management method (process management system) according to this embodiment is used to manage a process including work being performed by a person. As used herein, the “person” refers to a worker who is engaged in manufacturing products at a facility such as a factory. Also, the “work” as used herein refers to the work to be performed repeatedly by a person to produce the products. That is to say, if one product is produced through the work performed in one or more processes, multiple products will be produced sequentially by making a person repeatedly perform the work in each process. Examples of the work performed by the person may include work by cell production system and work by line production system. Also, examples of the work by the cell production system may include work by a method in which a product is completed by a single worker, i.e., a so-called “stand-alone manufacturing” method. In the embodiment to be described below, the work performed by the person is supposed to be work by the stand-alone manufacturing method.

The process management system may be used to, for example, analyze the work being performed by a person in a facility, i.e., to make an industrial engineering (IE) analysis. In another example, the process management system may also be used to improve a quality control (QC) process chart.

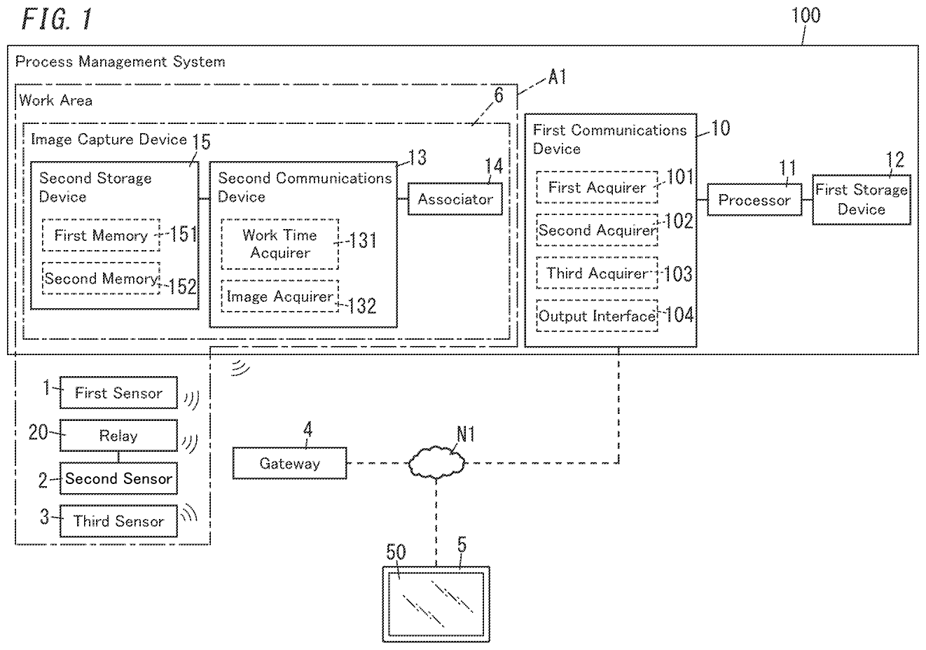

As shown in FIG. 1, the process management system 100 includes a first acquirer 101, a second acquirer 102, and a processor 11.

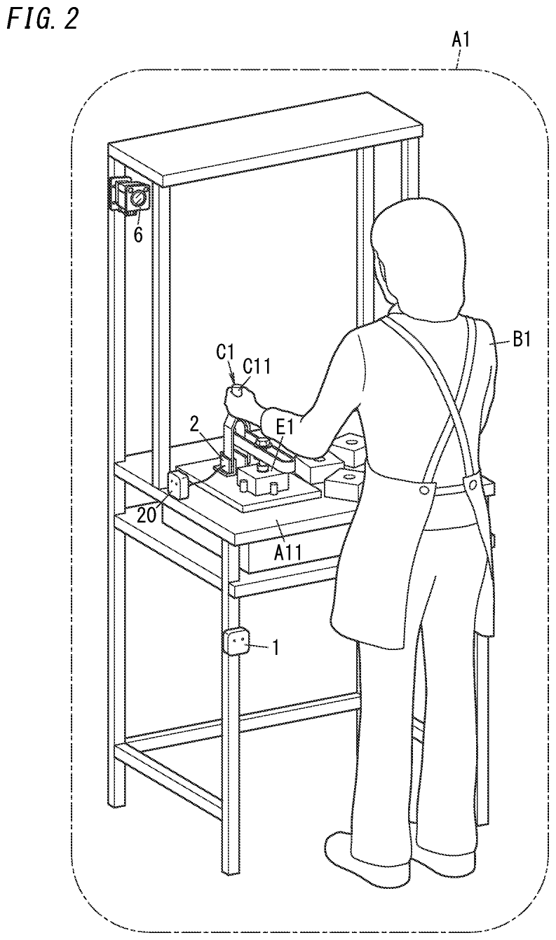

The first acquirer 101 acquires first time information about a time for which a person B1 (see FIG. 2) is present in a work area A1. As used herein, the “work area” refers to an area where the person B1 performs work in a facility. In this embodiment, the work area A1 is an area including a work stand A11 (see FIG. 2) at which the person B1 performs the work. Note that there are a plurality of work stands A11 in the facility because each of a plurality of persons B1 performs his or her work at the work stand A11 allocated to him or her. In this case, the work area A1 is an area including one work stand A11 out of the plurality of work stands A11 and not including any other work stand A11. Note that the person B1 does not have to be a single particular worker but may also refer to a team of workers in a situation where a plurality of workers are supposed to work as a team at a single work stand A11. Furthermore, the “first time information” as used herein may refer to either the amount of time that has passed since the person B1 entered the work area A1 and until he or she leaves the work area A1 or a time when he or she entered the work area A1 and/or a time when he or she left the work area A1.

The second acquirer 102 acquires second time information about an operating time for which the person B1 performs a predetermined operation in the work area A1. As used herein, the “predetermined operation” refers to an operation included in the work being performed by the person B1 and may be either the operation of the person B1 him- or herself or the operation of a jig C1 (see FIG. 2) used by the person B1 to perform the work. Also, the “second time information” as used herein may refer to the time it takes to perform the predetermined operation or may also refer to a start time of the predetermined operation and/or end time of the predetermined operation. Furthermore, the “predetermined operation” as used herein may refer to either a single operation or one or more operations out of two or more operations to be performed to have the work done in a single process.

The processor 11 acquires, based on the first time information and the second time information, work information about the work being performed by the person B1 and including the predetermined operation. For example, suppose a situation where the first acquirer 101 continues to acquire, as the first time information, the amount of time that has passed since the person B1 entered the work area A1 and until he or she leaves the work area A1. In that case, the processor 11 acquires the time for which the person B1 stays in the work area A1 as the time during which the person B1 may perform the work (as a piece of work information). Also, as an example, suppose a situation where the second acquirer 102 continues to acquire, as the second time information, the start time and end time of the predetermined operation. In that case, the processor 11 acquires an interval between the start times of the predetermined operation as the time it takes for the person B1 to have the work done (as a piece of work information).

As described above, according to this embodiment, work information about the work being performed by the person B1 in the work area A1 is acquired based on the first time information and the second time information. Thus, this embodiment makes it easier to recognize the state of the work being performed by the person Bl, compared to a situation where only the operating time of production equipment (including the jig C1) is acquired.

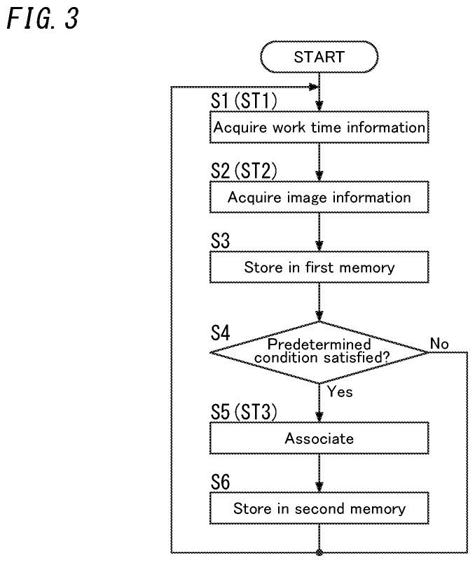

Also, the process management method according to this embodiment includes a work time acquisition step ST1 (see FIG. 3), an image acquisition step ST2 (see FIG. 3), and an association step ST3 (see FIG. 3). The work time acquisition step ST1, the image acquisition step ST2, and the association step ST3 are respectively performed by a work time acquirer 131, an image acquirer 132, and an associator 14 of the process management system 100 shown in FIG. 1.

The work time acquisition step ST1 includes acquiring work time information about a work time for which the person B1 performs work, including the predetermined operation, in the work area A1. As used herein, the “work time” refers to the length of time between a point in time when the jig C1 (see FIG. 2) starts to operate (to perform the predetermined operation) to do one task of the work and a point in time when the jig C1 starts to operate to do the next task of the work. That is to say, in a normal state, the person B1 repeatedly performs work, including a predetermined operation (e.g., the operation of the jig C1 in this example), in cycles. Thus, one cycle of the predetermined operation generally agrees with one cycle of the work (in other words, agrees with the work time). In this embodiment, the work time acquisition step ST1 includes acquiring (i.e., the work time acquirer 131 acquires) the work time information by communicating with a first communications device 10 (to be described later).

The image acquisition step ST2 includes acquiring image information about an image captured by an image capture device 6 (see FIGS. 1 and 2) and covering at least the work area A1. The image capture device 6 is installed, for example, in or around the work area A1. The “image” as used herein may refer to a still picture or a moving picture, whichever is appropriate. Also, the moving picture may also be a series of still pictures shot at an interval that is short enough to make the person's B1 motion in the work area A1 recognizable. In this embodiment, the image is a moving picture. Also, in this embodiment, the image acquisition step ST2 includes making (i.e., the image acquirer 132 makes) the image capture device 6 acquire the image information.

The association step ST3 includes associating the work time information acquired in the work time acquisition step ST1 and the image information acquired in the image acquisition step ST2 with each other as association information. That is to say, the association information is information that associates the person's B1 work time with the image (moving picture) that has been captured during the work time and covering the work area A1. For example, suppose a situation where the jig C1 starts operating to perform one task of the work at 1:00 pm and starts operating to perform the next task of the work at 1:03 pm. In that case, the association information is information in which the person's B1 work time from 1:00 pm through 1:03 pm and a moving picture shot during the period from 1:00 pm to 1:03 pm are associated with each other.

As can be seen, according to this embodiment, association information in which the work time and an image captured during the work time are associated with each other is acquired. Thus, this embodiment achieves the advantage of making it easier to recognize, by reference to the association information, the state of the work being performed by the person B1, compared to a situation where no reference is made to any images.

(2) Details

Next, the process management system 100 according to this embodiment will be described in detail with reference to FIGS. 1 and 2. The process management system 100 according to this embodiment actually manages the work being performed by a plurality of persons B1. Nevertheless, the following description will be focused on the management of the work being performed by each individual person B1, out of the plurality of persons B1, unless otherwise stated.

(2.1) Equipment in Work Area

First, the equipment for use in the work area A1 to which the process management system 100 is applied will be described in detail with reference to FIGS. 1 and 2. In this embodiment, the work area A1 is an area including a single work stand A11 at which the person B1 performs work by the stand-alone manufacturing method as described above. In the work area A1, installed are a first sensor 1, a second sensor 2, a relay 20, and the image capture device 6. In addition, around the work area A1, installed are a third sensor 3 and a gateway 4. Alternatively, the third sensor 3 and the gateway 4 may be both installed in the work area A1. Also, the image capture device 6 may also be installed around the work area A1 as long as the image capture device 6 may capture an image of at least the work area A1.

In this embodiment, none of the first sensor 1, the second sensor 2, the relay 20, the third sensor 3, and the gateway 4 are supposed to be counted among the constituent elements of the process management system 100. However, this is only an example and should not be construed as limiting. Alternatively, any of these may be counted among the constituent elements of the process management system 100. For example, the process management system 100 may further include the first sensor 1 and the second sensor 2.

The first sensor 1 is a reflective photoelectric sensor and is installed on the work stand A11. Specifically, as shown in FIG. 2, the first sensor 1 may be installed on one of the legs of the work stand A11 and arranged to be able to project light such as an infrared ray toward the space where the person B1 is present when performing his or her work at the work stand A11. The first sensor 1 includes a light-emitting device and a photosensor. The light-emitting device projects the light toward the space and the photosensor detects the presence or absence of the reflected light. In this manner, the first sensor 1 detects the presence or absence of the person B1 in/from the work area A1. Specifically, when finding that the photosensor has received the reflected light, of which the quantity is equal to or greater than a predetermined quantity, the first sensor 1 detects the presence of the person B1 in the work area A1. Otherwise, the first sensor 1 detects the absence of the person B1 from the work area A1. In this case, an element in which the light-emitting device and the photosensor are integrated together may be used as the first sensor 1. Also, in this case, circuits serving as the light-emitting device, the photosensor, and other components may be housed in a single housing of the first sensor 1.

The first sensor 1 includes a wireless communications module for establishing either optical wireless communication that uses light such as infrared ray or visible light as a medium or wireless communication that uses radio waves as a medium between the gateway 4 and the first sensor 1 itself. The first sensor 1 makes the wireless communications module transmit a result of detection by the first sensor 1 to the gateway 4. For example, if the result of detection by the first sensor 1 is represented as a binary signal, then the signal value of the binary signal is high level when the presence of the person B1 is detected and is low level unless the presence of the person B1 is detected. Optionally, the levels of the binary signal may also be reversed. The first sensor 1 and the gateway 4 are connected together via a different network from a network already installed in the facility.

The second sensor 2 may be either a contact-type sensor or a contactless sensor that uses magnetism, radio waves, or light, for example, and is installed on the work stand A11. In this embodiment, the second sensor 2 may be attached, for example, to the jig C1 to be used by the person B1 at the work stand A11. The jig C1 is used to be operated at least once every time the person B1 repeats the same type of work. In this embodiment, the jig C1 may be, for example, a toggle clamp for fixing a part E1.

The second sensor 2 detects the predetermined operation performed by the person B1 in the work area A1 by detecting the movement of a lever C11 that forms part of the jig C1. In the jig C1, the lever C11 is configured to be movable between a first position and a second position. When the lever C11 is at the first position, the jig C1 is not fixing the part E1, i.e., is not being used. On the other hand, when the lever C11 is at the second position, the jig C1 is fixing the part E1, i.e., is being used. Thus, when performing the work, the person B1 uses the jig C1 by gripping the lever C11 to turn the lever C11 from the first position to the second position. This allows the second sensor 2 to detect the predetermined operation (i.e., the operation of turning the lever C11) being performed by the person B1 in the work area A1 by detecting the movement of the lever C11. Specifically, when finding the lever C11 currently located at the second position, the second sensor 2 determines that the predetermined operation should be being performed. On the other hand, when finding the lever C11 currently located at the first position, the second sensor 2 determines that the predetermined operation should not be being performed.

The second sensor 2 includes a wired communications module for establishing wired communication between the relay 20 and the second sensor 2 itself via a communication cable. The second sensor 2 makes the wired communications module transmit the result of detection by the second sensor 2 to the relay 20. Note that the second sensor 2 does not have to be configured to establish wired communication but may also be configured to establish short-range wireless communication, for example. For example, if the result of detection by the second sensor 2 is represented by a binary signal, then the signal value of the binary signal is high level when the predetermined operation is detected and is low level unless the predetermined operation is detected. Optionally, the levels of the binary signal may also be reversed.

The image capture device 6 is a camera including, for example, a solid-state image sensor such as a charge-coupled device (CCD) image sensor or a complementary metal-oxide semiconductor (CMOS) image sensor and is installed on the work stand A11. In this embodiment, the image capture device 6 is installed on one of the pillars of the work stand A11. This allows the image capture device 6 to cover at least the work area A1 within its image capturing range. In this embodiment, the image capture device 6 is arranged to be able to capture an image of not only the operation being performed by the person B1 using the jig C1 but also any other type of operation being performed by the person B1 without using the jig C1. Examples of the person's B1 operation other than the operation using the jig C1 may include the operation of unloading the part E1 from a pallet placed in the work area A1. In addition, in this embodiment, the image capture device 6 captures a moving picture within the image capturing range.

The image capture device 6 includes a wireless communications module for establishing either optical wireless communication that uses light such as infrared ray or visible light as a medium or wireless communication that uses radio waves as a medium between the gateway 4 and the image capture device 6 itself. The image capture device 6 makes the wireless communications module transmit the image (moving picture) captured to the gateway 4. The image capture device 6 and the gateway 4 are connected together via a different network from the network already installed in the facility.

The relay 20 includes: a connection interface that allows one or more second sensors 2 to be connected thereto either via cables or wirelessly; and a wireless communications module. In this embodiment, if one or more second sensors 2 and one or more image capture devices 6 are connected together via cables, then the one or more second sensors 2 and the one or more image capture devices 6 are respectively connected to the connection interface of the relay 20 via communications cables. Alternatively, the relay 20 may also be configured such that a plurality of second sensors 2 and a plurality of image capture devices 6 are connected thereto by a communication method that uses bus lines, for example. The wireless communications module establishes either optical wireless communication that uses light such as infrared ray or visible light as a medium or wireless communication that uses radio waves as a medium between the gateway 4 and the wireless communications module itself. The relay 20 has the capability of transmitting (relaying), to the gateway 4, the result of detection that has been sent out from one or more second sensors 2 connected to the relay 20 and an image that has been sent out from one or more image capture devices 6 connected to the relay 20. The relay 20 and the gateway 4 are connected together via a different network from the network already installed in the facility. In this embodiment, this network is the same as the network between the first sensor 1 and the gateway 4.

The third sensor 3 is an optical sensor and includes a photosensor for receiving the light emitted from a Signal Tower®. The Signal Tower® includes a plurality of lamps that are arranged side by side as towers and is installed in the facility. The Signal Tower® is used to visually notify surrounding person(s) of the operating status of its associated production equipment. The Signal Tower® may include, for example, a first lamp that emits green light, a second lamp that emits yellow light, and a third lamp that emits red light.

In this embodiment, the Signal Tower® may be used, for example, for a plurality of work stands A11. The Signal Tower® turns the first lamp ON when finding that the work is being performed normally at all of the plurality of work stands A11, turns the second lamp ON when finding that the work is suspended at any of the work stands A11, and turns the third lamp ON when finding that the work is suspended at all of the work stands A11. The third sensor 3 detects the status of the work being performed at the plurality of work stands A11 upon receiving the light emitted from the first, second, or third lamp.

The third sensor 3 includes a wireless communications module for establishing either optical wireless communication that uses light such as infrared ray or visible light as a medium or wireless communication that uses radio waves as a medium between the gateway 4 and the third sensor 3 itself. The third sensor 3 makes the wireless communications module transmit a result of detection by the third sensor 3 to the gateway 4. For example, if a signal indicating the result of detection by the third sensor 3 may have three values (namely, a first value, a second value, and a third value), then signal has the first value when the first lamp is ON. The signal has the second value when the second lamp is ON. The signal has the third value when the third lamp is ON. The third sensor 3 and the gateway 4 are connected together via a different network from the network already installed in the facility. In this embodiment, this network is the same as the network between the first sensor 1 and the gateway 4.

The gateway 4 has the capability of transmitting the data that has been received from any of the first sensor 1, the second sensor 2, and the third sensor 3 to a first communications device 10 (to be described later) of the process management system 100 via a network N1 such as the Internet. In addition, the gateway 4 also has the capability of transmitting the data received from the image capture device 6 to a second communications device 13 (to be described later) of the process management system 100 via the network Ni. In this embodiment, only one gateway 4 is provided. However, this is only an example and should not be construed as limiting. Alternatively, the gateway 4 may include a gateway provided for the first communications device 10 and a gateway provided for the second communications device 13.

In this embodiment, the gateway 4 is a wireless communications module that may be connected to the network N1 via a cellular phone network (carrier network) provided by a communications service provider, for example. Examples of the cellular phone network include the third generation (3G) network, the fourth generation (4G) network, and the fifth generation (5G) network. Alternatively, the gateway 4 may also communicate wirelessly with the first communications device 10 and the second communications device 13 by a wireless communication method compliant with a communications protocol such as the Wi-Fi® protocol. In that case, part or all of the communications between the gateway 4 and the first communications device 10 or the second communications device 13 is established via a different network N1 from the network already installed in the facility. Optionally, if a local area network (LAN) line, already installed in the facility, for example, is located in the vicinity of the work stand A11, then the gateway 4 may communicate with the first communications device 10 and the second communications device 13 via the LAN line.

(2.2) Process Management System

Next, a configuration for the process management system 100 will be described with reference to FIG. 1. In this embodiment, the process management system 100 is implemented as a system including the image capture device 6 and a processor provided at a remote location distant from the place where the plurality of work stands A11 are installed. The processor may be, for example, a server. Although the processor is provided outside the facility in this embodiment, the processor may also be provided inside the facility. As shown in FIG. 1, the process management system 100 includes the first communications device 10, the processor 11, a first storage device 12, the second communications device 13, the associator 14, and a second storage device 15. In this embodiment, the first communications device 10, the processor 11, and the first storage device 12 are provided for the processor. On the other hand, the second communications device 13, the associator 14, and the second storage device 15 are provided for the image capture device 6. Furthermore, although the first storage device 12 and the second storage device 15 are counted among the constituent elements of the process management system 100 according to this embodiment, the first storage device 12 and the second storage device 15 may also be counted out of the constituent elements of the process management system 100.

The first communications device 10 is a communications module that may be connected to the network N1 via, for example, the cellular phone network described above. The first communications device 10 is preferably a wireless communications module that is connectible wirelessly to the network N1. The first communications device 10 has the capability of communicating with the gateway 4 via the network N1 and the capability of communicating with a terminal device 5 via the network Ni. As used herein, the terminal device 5 refers to a terminal device used by the administrator of the process management system 100 (or the administrator of the facility) and may be, for example, a smartphone or a tablet computer. Alternatively, the terminal device 5 may also be a desktop personal computer or a laptop personal computer, for example. In this embodiment, the terminal device 5 may be, for example, a tablet computer including a display device 50 such as a liquid crystal display.

The first communications device 10 performs the functions of the first acquirer 101, the second acquirer 102, a third acquirer 103, and an output interface 104.

The first acquirer 101 acquires the result of detection by the first sensor 1 via the gateway 4 and the network N1. In this embodiment, the first acquirer 101 acquires, in association with each other, the result of detection by the first sensor 1 and a time stamp concerning the time when the first sensor 1 detected the person B1. As used herein, the “time when the first sensor 1 detected the person B1” is a point in time when the person B1 entered the work area A1 and/or a point in time when the person B1 left the work area A1. That is to say, the first acquirer 101 acquires first time information about the time for which the person B1 is present in the work area A1. In addition, the first time information also includes a time stamp concerning the time acquired (i.e., the point in time when the first sensor 1 detected the person B1). In this embodiment, the time stamp is assigned, for example, as a point in time when the gateway 4 acquires the result of detection from the first sensor 1. Thus, the time indicated by the time stamp is strictly different from, but generally agrees with, the point in time when the first sensor 1 acquired the result of detection.

The second acquirer 102 acquires the result of detection by the second sensor 2 via the relay 20, the gateway 4, and the network N1. In this embodiment, the second acquirer 102 acquires, in association with each other, the result of detection by the second sensor 2 and a time stamp concerning the time when the second sensor 2 detected the predetermined operation. As used herein, the “time when the second sensor 2 detected the predetermined operation” is a start time of the predetermined operation and/or an end time of the predetermined operation. That is to say, the second acquirer 102 acquires second time information about the operating time for which the person B1 performs the predetermined operation in the work area A1. In addition, the second time information includes a time stamp concerning the time acquired (i.e., the point in time when the second sensor 2 detected the predetermined operation). In this embodiment, the time stamp is assigned, for example, as the point in time when the gateway 4 acquires the result of detection by the second sensor 2. Thus, the time indicated by the time stamp is strictly different from, but generally agrees with, the point in time when the second sensor 2 acquired the result of detection.

In this embodiment, the second sensor 2 detects the movement of the lever C11 of the jig C1 as described above. Thus, the point in time when the second sensor 2 detects the predetermined operation corresponds to the point in time when the operation of the jig C1 (or the person B1) is detected. In this embodiment, the second acquirer 102 acquires, as the second time information, either the operating time of the jig C1 for use in the work area A1 (i.e., the point in time when the jig C1 starts to operate and/or the point in time when the jig C1 finishes operating) or the operating time for which the person B1 performs the work, for example.

Furthermore, in this embodiment, each of the first time information and the second time information includes a time stamp as described above. In other words, at least one of the first time information or the second time information includes a time stamp concerning the time acquired.

In this embodiment, each of the first sensor 1 and the relay 20 has a unique identifier. In addition, the first sensor 1 and the relay 20 respectively transmit the result of detection by the first sensor 1 and the result of detection by the second sensor 2, as well as their own identifier, to the gateway 4. Thus, the first time information acquired by the first acquirer 101 includes the identifier of the first sensor 1. Likewise, the second time information acquired by the second acquirer 102 includes the identifier of the relay 20. The first sensor 1 and the relay 20 are both installed on the work stand A11. Thus, these identifiers substantially correspond to the identifier of the person B1 who is working at the work stand A11. That is to say, the first acquirer 101 and the second acquirer 102 acquire the first time information and the second time information, respectively, on a person-by-person B1 basis.

The third acquirer 103 acquires the result of detection by the third sensor 3 via the gateway 4 and the network NE In this embodiment, the third acquirer 103 acquires, in association with each other, the result of detection by the third sensor 3 and a time stamp concerning the time when the third sensor 3 detected the status of work being performed at the plurality of work stands A11. In this embodiment, the time stamp is assigned, for example, as the point in time when the gateway 4 acquires the result of detection by the third sensor 3. Thus, the time indicated by the time stamp is strictly different from, but generally agrees with, the point in time when the third sensor 3 acquired the result of detection.

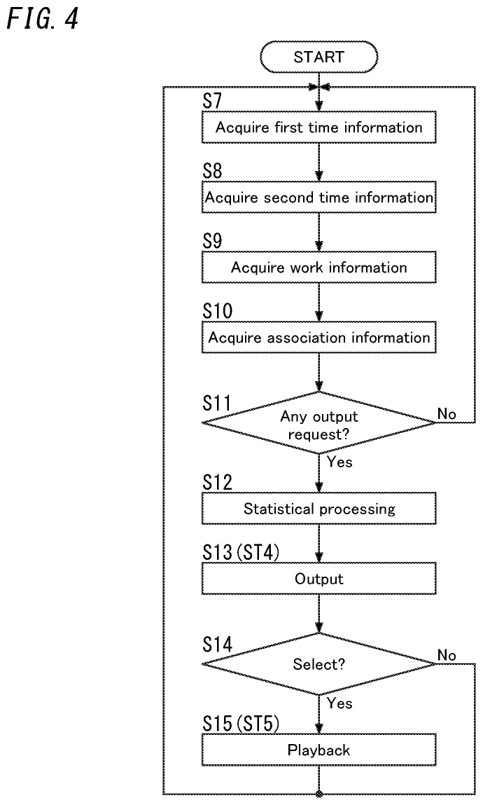

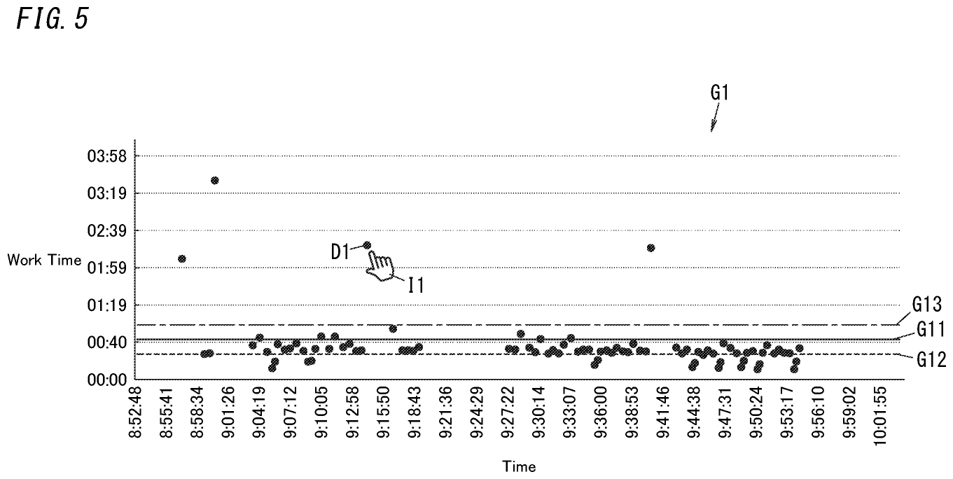

The output interface 104 transmits data to the terminal device 5 via the network N1. This data includes the work information acquired by the processor 11. The data will be displayed by a graphical user interface (GUI) on the display device 50. That is to say, the output interface 104 outputs (displays) (i.e., the display step ST4 (see FIG. 4) includes outputting (displaying)) the work information as visually recognizable data (i.e., a graph G1 (see FIG. 5)) to the display device 50. In this embodiment, on the display device 50 of the terminal device 5, the work information is not displayed as it is but statistical data, obtained by making the processor 11 perform statistical processing (to be described later) based on the work information, is displayed. In other words, the output interface 104 does not output the work information directly but outputs the work information indirectly as the data to be displayed on the display device 50. The statistical data will be described in detail later in the “(4) Exemplary statistical data” section.

The processor 11 is a computer system including one or more processors and a memory as principal hardware components. This processor 11 performs various functions by making the one or more processors execute a program stored in the memory. The program may be stored in advance in the memory of the processor 11. Alternatively, the program may also be downloaded through a telecommunications line or be distributed after having been recorded in some non-transitory storage medium such as an optical disc or a hard disk drive, both of which are readable for the computer system.

The processor 11 may acquire, based on the first time information acquired by the first acquirer 101, information about the time for which the person B1 stays in the work area A1 (hereinafter referred to as a “at-work time”), the time for which the person B1 has temporarily left the work area A1 (hereinafter referred to as an “off-work time”), or the number of times that the person B1 has temporarily left the work area A1. In addition, the processor 11 may also acquire, based on the second time information acquired by the second acquirer 102, information about the time it takes to perform the predetermined operation (e.g., the time for which the jig C1 is used in this example) or the number of times the predetermined operation has been performed (e.g., the number of times that the jig C1 has been used). This embodiment will be described on the supposition that a single task of the work includes performing the predetermined operation once and that a single task is performed on a single product. In that case, acquiring information about the number of times the predetermined operation has been performed allows the processor 11 to eventually acquire information about the number of the products produced.

In addition, the processor 11 also acquires information about the length of time between a point in time when the jig C1 starts to operate to perform one task of the work and a point in time when the jig C1 starts to operate to perform the next task of the work as the time for which the person B1 performs the work (hereinafter also referred to as a “work time”). That is to say, normally, the person B1 repeatedly performs work including the predetermined operation cyclically. Thus, the cycle of the predetermined operation generally agrees with the work cycle (in other words, generally agrees with the work time). In this manner, the processor 11 acquires, based on the first time information and the second time information, work information about the work including the predetermined operation and being performed by the person B1.

With this regard, in this embodiment, the first acquirer 101 and the second acquirer 102 acquire the first time information and the second time information, respectively, on a person-by-person B1 basis, as described above. Thus, in this embodiment, the processor 11 acquires, based on the first time information and second time information that are classified for each individual person Bl, the work information on a person-by-person B1 basis.

In addition, the processor 11 further acquires, based on the information acquired by the third acquirer 103 (i.e., the result of detection by the third sensor 3 and the time stamp), information about the status of the work being performed at a plurality of work stands A11.

Moreover, the processor 11 further has the capability of performing statistical processing based on the work information. Specifically, the processor 11 generates statistical data by performing appropriate statistical processing using the person's B1 at-work time and off-work time, the time for which the jig C1 is used, and/or the time it takes to have the work done. The statistical processing may be performed at regular intervals by the processor 11 or performed in response to an output request as a trigger, whichever is appropriate. As used herein, the “output request” refers to, for example, a command to be given from the terminal device 5 to the process management system 100 via the network N1 in response to the administrator's operating the terminal device 5. That is to say, when the administrator wants to check out the statistical data on the display device 50 of the terminal device 5, the output request is sent to the process management system 100.

The first storage device 12 may be implemented as, for example, at least one of a non-transitory storage medium such as a hard disk or a non-transitory storage medium such as a programmable nonvolatile semiconductor memory. In the first storage device 12, the work information acquired by the processor 11 and the association information associated by the associator 14 are stored in association with their corresponding person B1. That is to say, in the first storage device 12, the work information and the association information are stored on a person-by-person B1 basis. In addition, the statistical data, obtained by making the processor 11 perform the statistical processing, is also stored in the first storage device 12. The work information, association information, and/or statistical data that are stored in the first storage device 12 may be read out in response to an output request from the terminal device 5, for example.

The second communications device 13 is a communications module that is connectible to the network N1 via, for example, the cellular phone network described above. Note that the second communications device 13 is preferably a wireless communications module that is connectible wirelessly to the network N1. In this embodiment, the second communications device 13 is a wireless communications module included in the image capture device 6. The second communications device 13 performs the functions of the work time acquirer 131 and the image acquirer 132.

The work time acquirer 131 acquires (i.e., the work time acquisition step ST1 includes acquiring) the work time information from the first storage device 12 via the gateway 4, the network N1, and the first communications device 10. As described above, in this embodiment, the work information acquired by the processor 11 is stored in the first storage device 12 on a person-by-person B1 basis. Thus, the work time acquirer 131 acquires the work time information, out of the work information, on a person-by-person B1 basis from the first storage device 12 via the gateway 4, the network N1, and the first communications device 10.

The image acquirer 132 acquires (i.e., the image acquisition step ST2 includes acquiring) image information including the image captured by the image capture device 6. The image information includes not only the image itself but also time information about the point in time when the image was captured. In this embodiment, the time information conforms with the time clocked by a timer built in the image capture device 6.

In this embodiment, the image capture device 6 has a unique identifier. Thus, the image information acquired by the image acquirer 132 includes the identifier of the image capture device 6. The image capture device 6 is installed on the work stand A11. Thus, this identifier substantially corresponds to the identifier of the person B1 who is working at the work stand A11. That is to say, the image acquirer 132 acquires the image information on a person-by-person B1 basis.

The second storage device 15 may be implemented as, for example, at least one of a non-transitory storage medium such as a hard disk or a non-transitory storage medium such as a programmable nonvolatile semiconductor memory. The second storage device 15 includes a first memory 151 and a second memory 152. In the first memory 151, the work time information acquired by the work time acquirer 131 and the image information acquired by the image acquirer 132 are stored in association with their corresponding person B1. That is to say, in the first memory 151, the work time information and the image information are stored on a person-by-person B1 basis. In the second memory 152, association information, in which the work time information that has been determined by the associator 14 to satisfy a predetermined condition and image information corresponding to the work time information are associated with each other, is stored in association with their corresponding person B1. That is to say, in the second memory 152, the association information is stored on a person-by-person B1 basis. As can be seen, in this embodiment, the image information acquired by the image acquirer 132 is stored in the first memory 151 unconditionally. In the second memory 152, on the other hand, only the image information selected by the associator 14 (i.e., the association information) is stored.

The associator 14 is a computer system including one or more processors and a memory as principal hardware components. This associator 14 performs various functions by making the one or more processors execute a program stored in the memory. The program may be stored in advance in the memory of the associator 14. Alternatively, the program may also be downloaded through a telecommunications line or be distributed after having been recorded in some non-transitory storage medium such as an optical disc or a hard disk drive, both of which are readable for the computer system.

The associator 14 associates (i.e., the association step ST3 includes associating) the work time information acquired by the work time acquirer 131 (i.e., in the work time acquisition step ST1) and the image information acquired by the image acquirer 132 (i.e., in the image acquisition step ST2) with each other as association information. In this embodiment, the associator 14 associates (i.e., the association step ST3 includes associating) the work time information that satisfies the predetermined condition and the image information with each other. Specifically, the associator 14 reads out, from the first memory 151, the work time information and image information including an image captured during the work time included in the work time information. Then, the associator 14 determines whether or not the work time information satisfies the predetermined condition. When finding the work time information satisfying the predetermined condition, the associator 14 generates association information by associating the work time information and the image information that have been read out and makes the second memory 152 store the association information thus generated. On the other hand, when finding the work time information not satisfying the predetermined condition, the associator 14 discards the work time information and the image information that have been read out. In that case, the associator 14 may erase, from the first memory 151, the work time information and the image information that have been read out.

Next, examples of the predetermined condition will be enumerated one after another. In this embodiment, the associator 14 adopts at least one of the plurality of predetermined conditions enumerated below about the work time information.

One predetermined condition may be a condition that the work time should be equal to or longer than a threshold time. The threshold time may be set at an amount of time which is longer than a normal work time that it usually takes for the person B1 to have the work done and which it would take if any abnormality occurred during the work. Specifically, if the normal work time that it usually takes for the person B1 to have the work done is about 30 seconds on average, it may be an option to set the threshold time at about one minute. Naturally, the threshold time may also be set at the normal work time that it usually takes for the person B1 to have the work done. The threshold time may be set by making the administrator operate the terminal device 5, for example. Adopting this predetermined condition allows the associator 14 to have the association information stored in the second memory 152 in a situation where some abnormality would have occurred during the work.

Another predetermined condition may be a condition that the work time should fall within a preset time range that has been set. The preset time range may be set based on, for example, the average of the normal work time that it usually takes for the person B1 to have the work done. Specifically, if the normal work time that it usually takes for the person B1 to have the work done is 30 seconds, then it may be an option to set the preset time range within the range from 20 seconds to 40 seconds. The preset time range may be set by making the administrator operate the terminal device 5, for example. Adopting this predetermined condition allows the associator 14 to make the second memory 152 store, as the association information, information about the state of the work being performed by the person B1 in a normal state where no abnormality has occurred.

In this case, the preset time range may be set based on a representative value of the work time during a time slot that has been specified in advance. The representative value may be, for example, an average, a median, or a mode. For example, suppose the time slot that has been specified in advance is from 11 am to 12 am and the representative value is an average. In that case, the associator 14 reads out, from the first memory 151, work time information that has been acquired during the period from 11 am to 12 am and calculates an average (as a representative value) of the work time based on the entire work time information that has been read out. Then, the associator 14 sets a preset time range based on the average thus calculated and makes the second memory 152 store, as association information, the work time information falling within the range of the preset time range that has been set and its associated image information. The time slot and the representative value may be set by, for example, making the administrator operate the terminal device 5. This implementation enables automatically setting a preset time range that generally meets the administrator's request even without having the administrator set the preset time range by him- or herself.

(3) Operation

Next, an exemplary operation of the process management system 100 according to this embodiment will be described. In this embodiment, the process management system 100 performs a first operation and a second operation. The first operation is performed mainly by the associator 14. The second operation is performed mainly by the processor 11. The first operation and the second operation may be performed at mutually different timings or in parallel with each other, whichever is appropriate.

(3.1) First Operation

First, an exemplary first operation to be performed by the process management system 100 according to this embodiment will be described with reference to FIG. 3. First, work time information, out of the work information acquired by the processor 11, is transmitted to the second communications device 13 at regular intervals. This allows the work time acquirer 131 to acquire the work time information at regular intervals (in S1). This processing step S1 corresponds to the work time acquisition step ST1. Also, image information including an image captured by the image capture device 6 is transmitted to the second communications device 13 at regular intervals. This allows the image acquirer 132 to acquire the image information at regular intervals (in S2). This processing step S2 corresponds to the image acquisition step ST2. The work time information and the image information thus acquired are stored in the first memory 151 of the second storage device 15 (in S3).

Then, the associator 14 reads out the work time information and the image information from the first memory 151 either at regular intervals or every time a certain number of pieces of work time information have been accumulated and determines whether or not the work time information that has been read out satisfies a predetermined condition (in S4). When finding the work time information satisfying the predetermined condition (if the answer is YES in S4), the associator 14 associates the work time information and corresponding image information with each other (in S5). This processing step S5 corresponds to the association step ST3. Then, the associator 14 makes the second memory 152 of the second storage device 15 store, as association information, the work time information and the image information that are associated with each other (in S6). Thereafter, the process management system 100 repeatedly performs this series of processing steps S1-S6 over and over again.

(3.2) Second Operation

Next, an exemplary second operation to be performed by the process management system 100 according to this embodiment will be described with reference to FIG. 4. First, a result of detection by the first sensor 1 in the work area A1 is transmitted at regular intervals to the first communications device 10 via the gateway 4 and the network N1. This allows the first acquirer 101 to acquire first time information, including the result of detection by the first sensor 1 and a time stamp, at regular intervals (in S7). Also, a result of detection by the second sensor 2 in the work area A1 is transmitted at regular intervals to the first communications device 10 via the relay 20, the gateway 4 and the network N1. This allows the second acquirer 102 to acquire second time information, including the result of detection by the second sensor 2 and a time stamp, at regular intervals (in S8). Then, the processor 11 acquires work information at regular intervals based on the first time information acquired by the first acquirer 101 and the second time information acquired by the second acquirer 102 (in S9). The work information thus acquired is stored in the first storage device 12. The processor 11 further acquires the association information at regular intervals from the second memory 152 of the second storage device 15 via the gateway 4, the network N1, and the second communications device 13 (in S10). The association information thus acquired is stored in the first storage device 12.

In this case, if there is no output request (if the answer is NO in S11), the process management system 100 repeatedly performs these processing steps S7-S10. On the other hand, if there is any output request (if the answer is YES in S11), then the processor 11 performs statistical processing based on the work information thus acquired (including the work information stored in the first storage device 12) (in S12). In this manner, the processor 11 generates statistical data in response to the output request, i.e., in accordance with the operating command entered by the administrator through the terminal device 5. Then, the processor 11 transmits the statistical data thus generated to the terminal device 5 via the first communications device 10 and the network N1. That is to say, the output interface 104 outputs the statistical data to the terminal device 5 (in S13). This processing step S13 corresponds to the display step S14.

Thereafter, when any piece of work information, included in the statistical data (graph G1), is selected in response to the command entered by the administrator through the terminal device 5 (if the answer is YES in S14), the processor 11 reads out, from the first storage device 12, image information included in the association information corresponding to the work information thus selected and outputs the image information thus read to the terminal device 5 through the output interface 104, thereby having the image information played back on the display device 50 of the terminal device 5 (in S15). This processing step S15 corresponds to the playback step STS. The playback step ST5 is the step of playing back, when the work time information is selected on the graph G1, the image information, associated with the work time information selected, on the display device 50.

As used herein, “to play back image information” refers to playing back, if an image included in the image information is a still picture, the still picture on the display device 50. On the other hand, if an image included in the image information is a moving picture, then “to play back image information” as used herein may refer to not only playing back the moving picture on the display device 50 but also playing back a still picture, clipped out of the moving picture at a point in time, on the display device 50 as well. In the latter case, the moving picture is played back in response to an operating command entered by the administrator through the terminal device 5.

Thereafter, the process management system 100 repeatedly performs this series of processing steps S7-S15 over and over again. Optionally, the process management system 100 may also be configured to perform the statistical processing and store the result in the first storage device 12, every time the work information is acquired. In that case, if there is any output request, the processor 11 outputs the statistical data stored in the first storage device 12 to the terminal device 5.

(4) Examples of Statistical Data

Next, examples of the statistical data output by the output interface 104 (in other words, examples of the statistical data displayed on the display device 50 of the terminal device 5) will be presented. Note that the following examples of the statistical data are data about a single person B1 unless otherwise stated.

The statistical data shown in FIG. 5 shows a dispersion in the person's B1 work time during a particular time slot of one day. Specifically, a graph G1, of which the ordinate indicates the work time, and the abscissa indicates the time, is displayed as statistical data on the display device 50. That is to say, the graph G1 is rendered as a two- or higher-dimensional image including at least the work time and a point in time when the work time is acquired. FIG. 5 shows exemplary statistical data in a time slot from approximately 8:50 through approximately 10:00.

This graph G1 is displayed on the display device 50 in a form including a first line G11, a second line G12, and a third line G13 as shown in FIG. 5. The first line G11 indicates an average of the person's B1 work time. Alternatively, the first line Gll may indicate a median of the person's B1 work time, instead of the average of the person's B1 work time. The second line G12 indicates the work time in a situation where the person B1 has performed standard work (in other words, indicates a target value of the person's B1 work time). The third line G13 indicates a threshold time for use to determine whether the person's B1 work time is a normal value or an abnormal value (outlier). That is to say, if the work time is equal to or longer than the threshold time indicated by the third line G13, then the processor 11 counts the work time as an abnormal value. In this embodiment, the target value of the person's B1 work time and the threshold time are both set in advance by the administrator.

The administrator may recognize a dispersion in the person's B1 work time by checking out the graph G1 on the terminal device 5. In addition, the administrator may also recognize an abnormal value in work time (in other words, occurrence of any abnormality during the work) by checking out the graph G1 on the terminal device 5. Thus, this may also contribute to improving the work by investigating the cause of the abnormality. Optionally, the administrator may appropriately change the scale of the work time and/or the scale of the time on the graph G1 by performing a predetermined operation at the terminal device 5.

Suppose the administrator has selected, for example, data D1 on the graph G1 shown in FIG. 5 by operating the terminal device 5. The data D1 is data at which the work time is equal to or longer than the threshold time, i.e., data that satisfies the predetermined condition. The icon I1 shown in FIG. 5 indicates that the administrator has selected the data D1 by operating the terminal device 5. In response, the processor 11 reads out, in accordance with the work time information included in the data D1 selected, association information corresponding to this work time information from the second memory 152. Then, the processor 11 has image information, included in the association information thus read, played back on the display device 50.

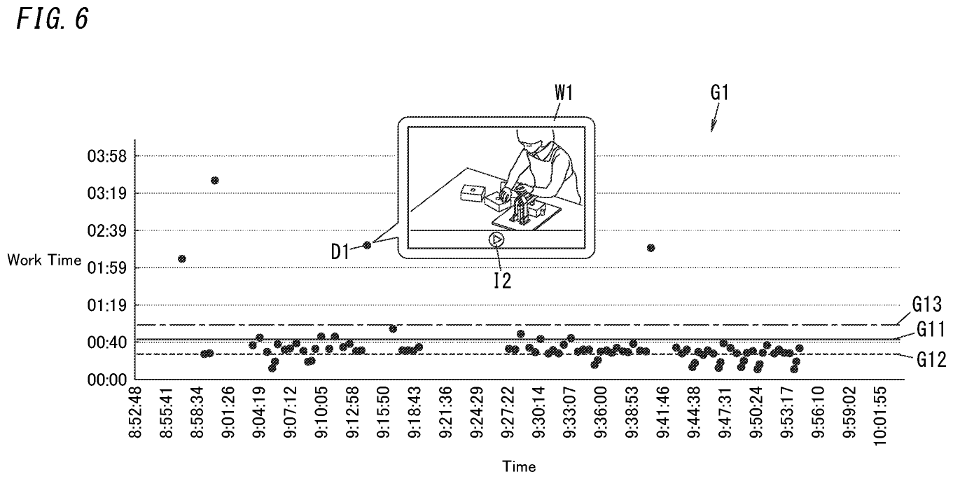

In this embodiment, the processor 11 has an image, clipped at a certain point in time from an image (moving picture) included in the image information thus read and a triangular arrow icon I2 pointing to the right to allow the user to selectively play back or stop playing this image, displayed in a window W1 superimposed on the graph G1 as shown in FIG. 6. When the administrator selects the icon 12 while the image displayed in the window W1 is paused (i.e., is not played), the processor 11 has the image (moving picture) displayed in the window W1 played back. On the other hand, when the administrator selects the icon 12 while the image (moving picture) is being played back in the window W1, the processor 11 pauses the playback of the image being displayed in the window W1 .

Next, an advantage of the process management system 100 (process management method) according to this embodiment will be described with the process management system 100 compared with a process management system according to a comparative example. The process management system (process management method) according to the comparative example includes neither the second communications device 13 (that performs the work time acquisition step ST1 and the image acquisition step ST2) nor the associator 14 (that performs the association step ST3), which is a difference from the process management system 100 (process management method) according to this embodiment. The process management system according to the comparative example allows, as well as the process management system 100 according to this embodiment, the administrator to check out the graph G1 on the display device 50 of the terminal device 5.

However, the process management system according to the comparative example allows the administrator to just check out the graph G1, i.e., check out the work time as a state of the work being performed by the person B1. Thus, the process management system according to the comparative example does not allow, even if the administrator has discovered any data, indicating that the work time is so long as to be a possible sign of occurrence of some abnormality, while checking out the graph G1, for example, the administrator to view an image (moving picture) representing the work corresponding to such data. Also, even if the work being performed by the person B1 has been captured by the image capture device, the administrator cannot view an image representing the work corresponding to the data without going through a troublesome job of finding an image falling within a time slot corresponding to the data in the entire image (moving picture) captured by the image capture device.

In contrast, the process management system 100 according to this embodiment enables acquiring the association information that associates work time and an image captured during the work time with each other as described above. Thus, this embodiment allows, if the administrator has discovered any data, indicating that the work time is so long as to be a possible sign of occurrence of some abnormality, while checking out the graph G1, for example, the administrator to immediately view an image (moving picture) corresponding to such data by reference to the association information. That is to say, this embodiment allows the administrator to recognize, by viewing an image (moving picture) pinpointing an exact point in time when the abnormality is presumed to have occurred, whether or not any abnormality has actually occurred and in what situation the abnormality, if any, has occurred. Thus, this embodiment contributes to significantly shortening the time it takes to analyze the image. Consequently, this embodiment achieves the advantage of making it easier, by reference to the association information, to recognize the state of the work being performed by the person B1, compared to the process management system (process management method) according to the comparative example.

In this case, the administrator may select a plurality of data items. If a plurality of data items have been selected, then multiple pieces of image information, respectively corresponding to those data items, are played back on the display device 50 of the terminal device 5. That is to say, the playback step ST5 includes playing back, when multiple pieces of work time information are selected on the graph G1, multiple pieces of image information, respectively associated with the multiple pieces of work time information selected, on the display device 50.

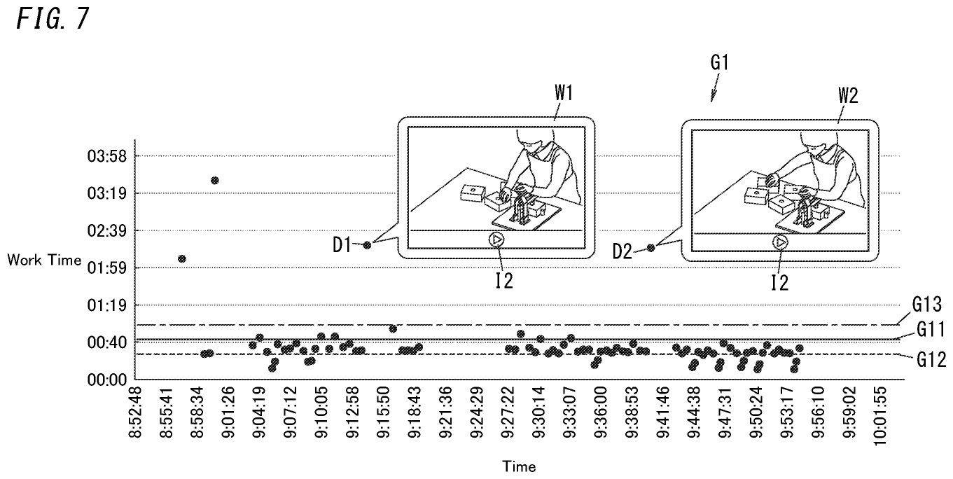

For example, suppose that the administrator has selected two data items D1, D2 as shown in FIG. 7 by operating the terminal device 5. The data item D2, as well as the data item D1, satisfies the predetermined condition. In response, the processor 11 has two pieces of image information, respectively corresponding to the two data items D1, D2, selected, played back on the display device 50. In this case, a window W1 presenting an image corresponding to the data item D1 and another window W2 presenting an image corresponding to the data item D2 are displayed on the display device 50 to be superimposed on the graph G1. This implementation allows the administrator to compare the work being performed by a person B1 during one work time with the work being performed by the person B1 during another work time. For example, the administrator may compare the work being performed by a person B1 when the work time is approximately a standard time with the work being performed by the person B1 when the work time is so long as to be possible sign of occurrence of some abnormality, by playing back both images (moving pictures) simultaneously.

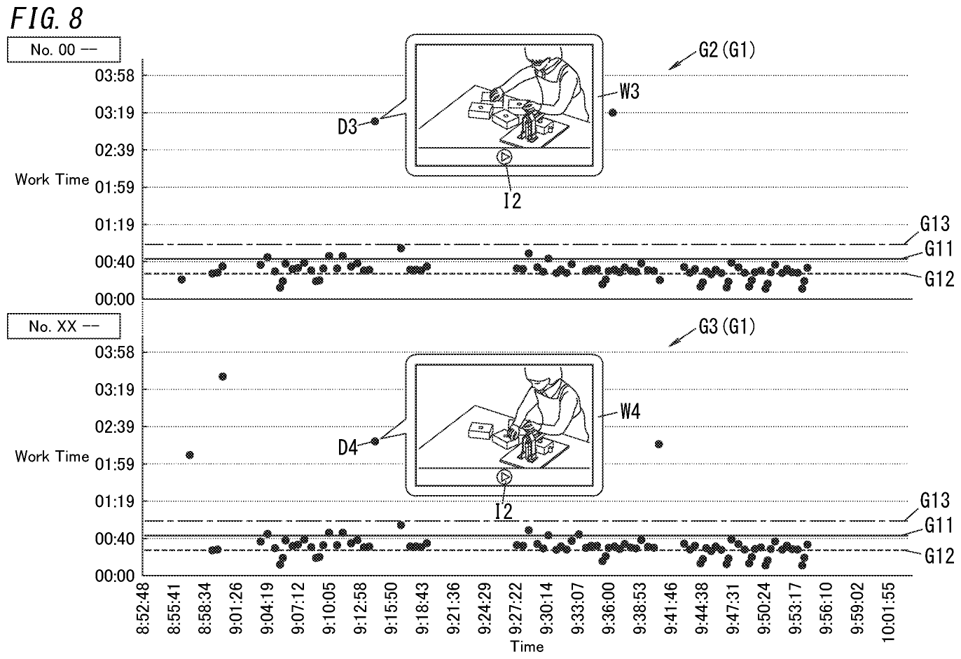

In the example illustrated in FIG. 7, only the graph G1 with respect to a single person's B1 work is displayed on the display device 50. However, this is only an example and should not be construed as limiting. Alternatively, the administrator may have a plurality of graphs G1 with respect to a plurality of persons' B1 work displayed on the display device 50 by performing a predetermined operation at the terminal device 5. In the example illustrated in FIG. 8, a graph G2 with respect to the work being performed by a person B1 with an identifier “No. 00” and a graph G3 with respect to the work being performed by another person B1 with an identifier “No. XX” are displayed on the display device 50.

Also, suppose the administrator has selected a data item D3 on the graph G2 and a data item D4 on the graph G3. Both of these data items D3, D4, as well as the data items D1, D2, satisfy the predetermined condition. In response, the processor 11 has two pieces of image information, respectively corresponding to the two data items D3, D4 selected, played back on the display device 50. In this case, a window W3, representing an image corresponding to the data item D3, is displayed on the display device 50 to be superimposed on the graph G2 and a window W4, representing an image corresponding to the data item D4, is displayed on the display device 50 to be superimposed on the graph G3. This implementation allows the administrator to compare the work being performed by multiple different persons B1. For example, the administrator may compare, for example, the work being performed by one person B1 who is a skilled worker with the work being performed by another person B1 who is a beginner by simultaneously playing back the images (moving pictures) representing their respective work processes.

(5) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. The functions of the process management method described above may also be implemented as, for example, a computer program or a non-transitory storage medium that stores the computer program thereon. A program according to an aspect is designed to cause one or more processors to perform the process management method described above.

Next, variations of the exemplary embodiment described above will be enumerated one after another. Note that the variations to be described below may be adopted in combination as appropriate.

(5.1) First Variation

A process management system 100 (process management method) according to a first variation includes an adjuster 16, which is a difference from the process management system 100 according to the exemplary embodiment described above. The adjuster 16 is an agent that performs an adjustment step. The adjustment step includes adjusting, in accordance with a command entered, a playback time for which the image information is played back in the playback step STS. As used herein, the “command” may be a command entered by an administrator, for example, i.e., by making the administrator operate the terminal device 5. The adjustment step includes accepting an externally entered command and adjusting, in accordance with the command entered, the playback time for which the image information is played back in the playback step ST5. The externally entered command may be, for example, a command entered by the administrator.

In the exemplary embodiment described above, the image (moving picture) is played back in the playback step ST5 for a duration corresponding to the work time. On the other hand, according to this variation, the adjuster 16 may adjust the playback time of the image (moving picture) in accordance with the command entered. Specifically, on accepting a command entered by the administrator, the adjuster 16 adjusts, in accordance with the command entered, the playback time (by setting a start time and an end time) of the image (moving picture) to be stored in the second memory 152 by the associator 14. Thus, when making the second memory 152 store the association information, the associator 14 makes the second memory 152 store image information including an image (moving picture) with the playback time adjusted by the adjuster 16.

For example, the adjuster 16 may adjust the playback time in accordance with the command entered such that the playback time begins at a point in time earlier than a start time of the work time. In addition, the adjuster 16 may also adjust the playback time in accordance with the command entered such that the playback time ends at a point in time later than an end time of the work time. Furthermore, the adjuster 16 may also adjust the playback time in accordance with the command entered such that only a part of the work time except the operating time (i.e., the time for which the person B1 is using the jig C1), i.e., a preparatory time, is the playback time.

(5.2) Second Variation

A process management system 100 (process management method) according to a second variation includes a synchronizer 17, which is a difference from the process management system 100 according to the exemplary embodiment described above. The synchronizer 17 is an agent that performs a synchronization step. The synchronization step includes synchronizing the work time acquisition step ST1 and the image acquisition step ST2 with each other. The synchronizer 17 acquires standard time information from a network time protocol (NTP) server, for example, and updates the timer of the process management system 100 in accordance with the standard time information thus acquired. In addition, the synchronizer 17 transmits the standard time information via the gateway 4 and the network N1 to the image capture device 6, the first sensor 1, and the second sensor 2, for example, thereby updating the respective timers of the image capture device 6, the first sensor 1, and the second sensor 2. In this case, these timers are preferably updated with a delay involved with communication taken into account.

Updating the respective timers of the process management system 100, the image capture device 6, the first sensor 1, and the second sensor 2 in this manner in accordance with the standard time information allows the work time acquisition step ST1 and the image acquisition step ST2 to be synchronized with each other eventually. That is to say, this allows the point in time when the work time information is acquired by the work time acquirer 131 and the point in time when the image information is acquired in the image acquisition step ST2 to be based on timers that tick approximately the same time.

(5.3) Other Variations

The process management system 100 according to the present disclosure includes a computer system. The computer system may include a processor and a memory as principal hardware components. The functions of the process management system 100 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be implemented as a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very large-scale integrated circuit (VLSI), and an ultra-large-scale integrated circuit (ULSI). Optionally, an FPGA to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

In the embodiment described above, the plurality of functions of the process management system 100 are aggregated together in a single server. However, this is not an essential configuration for the process management system 100. That is to say, those constituent elements of the process management system 100 may be distributed in multiple different servers. Still alternatively, at least some functions of the process management system 100 may be implemented as a cloud computing system as well. Yet alternatively, at least some functions of the process management system 100 may be implemented as the first sensor 1, the second sensor 2, the relay 20, the third sensor 3, or the gateway 4, each including with a computer system including, as major hardware components, one or more processors and a memory.

In the exemplary embodiment described above, at least part of the process management system 100 does not have to be implemented as a server but may also be implemented as an application installed in the terminal device 5.

In the exemplary embodiment described above, the first sensor 1 and the second sensor 2 do not have to identify the person B1 by the identifier. Alternatively, the person B1 may also be identified by either intra-body communication that uses the person's B1 body as a transmission medium or using an identification tag carried by the person B1 with him or her.

In the exemplary embodiment described above, the second sensor 2 detects a predetermined operation by detecting the movement of the jig C1. However, this is only an example and should not be construed as limiting. Alternatively, the second sensor 2 may also detect the predetermined operation by detecting the motion of the person B1 who is using the jig C1. Suppose, for example, that there is a space that some part of the person B1 enters only when the person B1 uses the jig C1. In that case, the second sensor 2 may detect a predetermined operation being performed by the person B1 who is using the jig C1 by detecting the presence or absence of an object (such as the person's B1 arm) in/from this space. As can be seen, the predetermined operation is preferably detected as a particular type of work or operation during the work procedure. Alternatively, the predetermined operation may also be detected as a particular operation being performed separately from the particular type of work or operation.

In the exemplary embodiment described above, the time stamp associated with the result of detection by the first sensor 1 does not have to be assigned by the gateway 4 but may also be assigned by either the first sensor 1 or the first communications device 10. That is to say, the time stamp may be assigned by the first communications device 10 when the first communications device 10 acquires the result of detection by the first sensor 1. Alternatively, the time stamp may also be assigned to the result of detection by the first sensor 1 when the first sensor 1 detects the presence or absence of the person B1. Also, the time stamp associated with the result of detection by the second sensor 2 does not have to be assigned by the gateway 4 but may also be assigned by the second sensor 2, the relay 20, or the first communications device 10. That is to say, the time stamp may be assigned by the first communications device 10 when the first communications device 10 acquires the result of detection by the second sensor 2. Alternatively, the time stamp may also be assigned to the result of detection by the second sensor 2 when the second sensor 2 detects the operation. Still alternatively, the time stamp may also be assigned by the relay 20 when the relay 20 acquires the result of detection by the second sensor 2. Furthermore, the time stamp associated with the result of detection by the third sensor 3 does not have to be assigned by the gateway 4 but may also be assigned by either the third sensor 3 or the first communications device 10. That is to say, the time stamp may be assigned by the first communications device 10 when the first communications device 10 acquires the result of detection by the third sensor 3. Alternatively, the time stamp may also be assigned by the third sensor 3 when the third sensor 3 detects the status of the work.

In the exemplary embodiment described above, the first acquirer 101 may acquire the person's B1 duration of stay and off-work time without acquiring the time stamp. In that case, the person's B1 duration of stay and off-work time may be obtained by either the first sensor 1 or the gateway 4. Likewise, the second acquirer 102 may acquire the time it takes to perform the predetermined operation from the second sensor 2 without acquiring the time stamp. In that case, the time it takes to perform the predetermined operation may be obtained by the second sensor 2, the relay 20, or the gateway 4.

In the exemplary embodiment described above, the first sensor 1 has a configuration in which the light-emitting device and the photosensor are integrated together. However, this is only an example and should not be construed as limiting. Alternatively, the first sensor 1 may also have a configuration in which the light-emitting device and the photosensor are housed in mutually different housings. Furthermore, the first sensor 1 does not have to be configured to detect the reflected light at the photosensor thereof. Alternatively, the first sensor 1 may also be configured to detect the presence of the person B1 when detecting that the light projected from the light-emitting device has been cut off. That is to say, the first sensor 1 may also be a so-called “transmissive photoelectric sensor.”

In the exemplary embodiment described above, the first sensor 1 may transmit the result of detection to the gateway 4 via wired communication. In the same way, the second sensor 2 may also transmit the result of detection to the gateway 4 via wired communication. Likewise, the image capture device 6 may also transmit the image (moving picture) captured and the information stored in the second storage device 15 to the gateway 4 via wired communication.

In the exemplary embodiment described above, the second sensor 2 may include a wireless communications module for communicating wirelessly with the gateway 4. This implementation allows the second sensor 2 to transmit the result of detection to the gateway 4 not via the relay 20. Thus, no relay 20 is needed according to this implementation.

In the exemplary embodiment described above, only one gateway 4 is provided. However, this is only an example and should not be construed as limiting. Alternatively, a plurality of gateways 4 may also be provided. This allows, when data of a large size (such as the image (moving picture) captured by the image capture device 6) which tends to use a significant proportion of the communications band, is transmitted or received, for example, the communications load to be distributed among the plurality of gateways 4.

In the exemplary embodiment described above, each of the first sensor 1, the second sensor 2, and the third sensor 3 may also be configured to communicate wirelessly with the first communications device 10 of the process management system 100 via the network N1 but not via the gateway 4. This implementation eliminates the need to use the gateway 4.

In the exemplary embodiment described above, as long as the process management system 100 may acquire the result of detection from each of the first sensor 1 and the second sensor 2, the processor 11 may acquire the work information. Thus, in the exemplary embodiment described above, the third sensor 3 does not have to be installed in the facility.

In the exemplary embodiment described above, the jig C1 does not have to be a toggle clamp but an appropriate type of jig C1 may be selected by the person B1 on a work-by-work basis. For example, the jig C1 may also be an electric screwdriver. In that case, the second sensor 2 may be configured to determine, by detecting the amount of an electric current flowing through the jig C1, whether the jig C1 is operating or not. For instance, the second sensor 2 may also be a current sensor such as a current transformer, which is attached to a power cable of the jig C1 to detect an electric current flowing through the jig C1.

In the exemplary embodiment described above, the output interface 104 (display step ST4) may have the graph G1 displayed on the display device 50 such that data indicating that the work time is equal to or longer than a threshold time and data indicating that the work time is shorter than the threshold time are visually distinguishable from each other. For example, the output interface 104 may make the display device 50 present the former type of data as black dots and the latter type of data as light blue dots.

In the exemplary embodiment described above, the graph G1 is rendered as a two-dimensional image, of which the ordinate indicates the work time, and the abscissa indicates the time. However, this is only an example and should not be construed as limiting. Alternatively, the graph G1 may also be rendered as a three- or higher-dimensional image including the work time, the time, and at least one more parameter.

In the exemplary embodiment described above, the image capture device 6 may capture an image of the person B1 present in the work area A1 by tracking the person B1.

In the exemplary embodiment described above, the process management system 100 is implemented as a system including the image capture device 6 and one processor. However, this is only an example and should not be construed as limiting. Alternatively, the process management system 100 may also include a first processor including the first communications device 10, the processor 11, and the first storage device 12 and a second processor including the second communications device 13, the associator 14, and the second storage device 15. That is to say, the image capture device 6 may include none of the second communications device 13, the associator 14, or the second storage device 15. In such an implementation, the first communications device 10 and the second communications device 13 only need to communicate bidirectionally with each other via the network N1.

In the exemplary embodiment described above, the process management method only needs to include at least the work time acquisition step ST1, the image acquisition step ST2, and the association step ST3. Thus, the process management system 100 only needs to include at least the second communications device 13 (including the work time acquirer 131 and the image acquirer 132) and the associator 14. Therefore, the first communications device 10, the processor 11, the first storage device 12, and the second storage device 15 may be counted out of the constituent elements of the process management system 100.

(Recapitulation)

As can be seen from the foregoing description, a process management method according to a first aspect includes a work time acquisition step (ST1), an image acquisition step (ST2), and an association step (ST3). The work time acquisition step (ST1) includes acquiring work time information about a work time for which a person (B1) performs work, including a predetermined operation, in a work area (A1). The image acquisition step (ST2) includes acquiring image information about an image captured by an image capture device (6) and covering at least the work area (A1). The association step (ST3) includes associating the work time information acquired in the work time acquisition step (ST1) and the image information acquired in the image acquisition step (ST2) with each other as association information.

This aspect achieves the advantage of making it easier to recognize the state of the work being performed by a person (B1).

In a process management method according to a second aspect, which may be implemented in conjunction with the first aspect, the association step (ST3) includes associating the work time information satisfying a predetermined condition with the image information.

This aspect achieves the advantage of reducing the chances of nearly running out of the space for storing the association information by preventing unnecessary information that fails to satisfy the predetermined condition from being associated in vain.

In a process management method according to a third aspect, which may be implemented in conjunction with the second aspect, the predetermined condition includes a condition that the work time be equal to or longer than a threshold time.

This aspect allows the work time information to be associated with the image information only when it has taken an unusually long time to have the work done due to the occurrence of some abnormality, for example, thus achieving the advantage of reducing the chances of nearly running out of the space for storing the association information.

In a process management method according to a fourth aspect, which may be implemented in conjunction with the second aspect, the predetermined condition includes a condition that the work time fall within a preset time range that has been set.

This aspect achieves the advantage of allowing, for example, information about the state of the work being performed by the person (B1) in a normal condition without any abnormality to be stored as the association information.

In a process management method according to a fifth aspect, which may be implemented in conjunction with the fourth aspect, the preset time range is set based on a representative value of the work time during a time slot that has been specified in advance.

This aspect achieves the advantage of enabling automatically setting a preset time range that generally meets an administrator's request even without having the administrator set the preset time range by him- or herself.

A process management method according to a sixth aspect, which may be implemented in conjunction with any one of the first to fifth aspects, further includes a display step (ST4) and a playback step (ST5). The display step (ST4) includes displaying the work time information as a graph (G1) visually recognizable on a display device (50). The playback step (ST5) includes playing back, when the work time information is selected on the graph (G1), the image information, associated with the work time information selected, on the display device (50).

This aspect allows the administrator to view the image information associated with the work time information while checking out the graph (G1), thus achieving the advantage of making it even easier to recognize the state of the work being performed by the person (B1).

In a process management method according to a seventh aspect, which may be implemented in conjunction with the sixth aspect, the graph (G1) is rendered as a two- or higher dimensional image including at least the work time and a point in time when the work time is acquired.

This aspect achieves the advantage of making it easier to follow the person's (B1) work time along the time series.

In a process management method according to an eighth aspect, which may be implemented in conjunction with the sixth or seventh aspect, the display step (ST4) includes displaying, as the graph, two or more pieces of the work time information. The playback step (ST5) includes playing back, when multiple pieces of the work time information are selected on the graph (G1) from the two or more pieces of the work time information, multiple pieces of the image information, which are respectively associated with the multiple pieces of the work time information selected, on the display device (50).

This aspect achieves the advantage of making it even easier to recognize the state of the work being performed by the person (B1) by comparing multiple pieces of the image information with each other.

A process management method according to a ninth aspect, which may be implemented in conjunction with any one of the sixth to eighth aspects, further includes an adjustment step. The adjustment step includes adjusting, in accordance with a command entered, a playback time for which the image information is played back in the playback step (ST5).

This aspect achieves the advantage of allowing the administrator to view only the image information falling within his or her specified time slot.

A process management method according to a tenth aspect, which may be implemented in conjunction with any one of the first to ninth aspects, further includes a synchronization step. The synchronization step includes synchronizing the work time acquisition step (ST1) and the image acquisition step (ST2) with each other.

This aspect achieves the advantage of making it easier to reduce the time lag between the work time and a point in time when an image associated with the work time is acquired.

A program according to an eleventh aspect is designed to cause one or more processors to perform the process management method according to any one of the first to tenth aspects.

This aspect achieves the advantage of making it easier to recognize the state of the work being performed by a person (B1).

A process management system (100) according to a twelfth aspect includes a work time acquirer (131), an image acquirer (132), and an associator (14). The work time acquirer (131) acquires work time information about a work time for which a person (B1) performs work, including a predetermined operation, in a work area (A1). The image acquirer (132) acquires image information about an image captured by an image capture device (6) and covering at least the work area (A1). The associator (14) associates the work time information acquired by the work time acquirer (131) and the image information acquired by the image acquirer (132) with each other as association information.

This aspect achieves the advantage of making it easier to recognize the state of the work being performed by a person (B1).

A process management system (100) according to a thirteenth aspect, which may be implemented in conjunction with the twelfth aspect, further includes a first acquirer (101), a second acquirer (102), and a processor (11). The first acquirer (101) acquires first time information about a time for which the person (B1) is present in the work area (A1). The second acquirer (102) acquires second time information about an operating time for which the person (B1) performs the predetermined operation in the work area (A1). The processor (11) acquires, based on the first time information and the second time information, work information about the work.

This aspect achieves the advantage of making it easier to recognize the state of the work being performed by a person (B1).

Note that the features according to the second to tenth aspects are not essential features for the process management method but may be omitted as appropriate. Also, the constituent elements according to the thirteenth aspect are not essential constituent elements for the process management system (100) but may be omitted as appropriate.

### REFERENCE SIGNS LIST

100 Process Management System

101 First Acquirer

102 Second Acquirer

11 Processor

131 Work Time Acquirer

132 Image Acquirer

14 As sociator

50 Display Device

A1 Work Area

B1 Person

G1 Graph

ST1 Work Time Acquisition Step

ST2 Image Acquisition Step

ST3 Association Step

ST4 Display Step

ST5 Playback Step

1. A process management method comprising:
a work time acquisition step including acquiring work time information about a work time for which a person performs work, including a predetermined operation, in a work area;
an image acquisition step including acquiring image information about an image captured by an image capture device and covering at least the work area; and
an association step including associating the work time information acquired in the work time acquisition step and the image information acquired in the image acquisition step with each other as association information.

2. The process management method of claim 1, wherein
the association step includes associating the work time information satisfying a predetermined condition with the image information.

3. The process management method of claim 2, wherein
the predetermined condition includes a condition that the work time be equal to or longer than a threshold time.

4. The process management method of claim 2, wherein
the predetermined condition includes a condition that the work time fall within a preset time range that has been set.

5. The process management method of claim 4, wherein
the preset time range is set based on a representative value of the work time during a time slot that has been specified in advance.

6. The process management method of claim 1, further comprising:
a display step including displaying the work time information as a graph visually recognizable on a display device; and
a playback step including playing back, when the work time information is selected on the graph, the image information, associated with the work time information selected, on the display device.

7. The process management method of claim 6, wherein
the graph is rendered as a two- or higher dimensional image including at least the work time and a point in time when the work time information is acquired.

8. The process management method of claim 6, wherein
the display step includes displaying, as the graph, two or more pieces of the work time information; and
the playback step includes playing back, when multiple pieces of the work time information are selected on the graph from the two or more pieces of the work time information, multiple pieces of the image information, which are respectively associated with the multiple pieces of the work time information selected, on the display device.

9. The process management method of claim 8, further comprising an adjustment step including adjusting, in accordance with a command entered, a playback time for which the image information is played back in the playback step.

10. The process management method of claim 1, further comprising a synchronization step including synchronizing the work time acquisition step and the image acquisition step with each other.

11. A non-transitory storage medium that stores a program designed to cause one or more processors to perform the process management method of claim 1.

12. A process management system comprising:
a work time acquirer configured to acquire work time information about a work time for which a person performs work, including a predetermined operation, in a work area;
an image acquirer configured to acquire image information about an image captured by an image capture device and covering at least the work area; and
an associator configured to store association information associating the work time information acquired by the work time acquirer and the image information acquired by the image acquirer with each other.

13. The process management system of claim 12, further comprising:
a first acquirer configured to acquire first time information about a time for which the person is present in the work area;
a second acquirer configured to acquire second time information about an operating time for which the person performs the predetermined operation in the work area; and
a processor configured to acquire, based on the first time information and the second time information, work information about the work.
